(19) United States
(12) Patent Application Publication
(10) Pub. No.: US 2004/0226506 A1
(43) Pub. Date: Nov. 18, 2004

(54) Coated wafer processing equipment

(76) Inventor: David Mark Lynn, Eagle, ID (US)

Correspondence Address: Lawrence D. Graham, Esq., BLACK LOWE & GRAHAM PLLC, 816 Second Avenue, Seattle, WA, 98104, US

(21) Appl. No.: 10/438,552

(22) Filed: May 14, 2003

(51) Int. Cl. B05C 13/00; B05C 13/02

(52) U.S. Cl. 118/500

(57) ABSTRACT

The present invention comprises a wafer boat, bath, or related components that are covered with a fluoropolymer coating. In a preferred form, the components have standard quartz structures that are covered with a protective fluoropolymer coating. In alternate embodiments, glass, plastic, or even metal is used for the structure of the boat or related components, then covered with a protective layer of fluoropolymer. In accordance with another preferred aspect, the coating is clear. In alternate embodiments, however, the coating includes a pigment. In some preferred embodiments, the coating comprises multiple layers with different colors for each layer so that wear will be readily apparent.

### FIELD OF THE INVENTION

This invention relates generally to equipment used for processing semiconductor wafers, particularly including carriers, baths, and related components.

### BACKGROUND OF THE INVENTION

Silicon or other semiconductor wafers are processed in a variety of ways in order to produce wafers suitable for various semiconductor applications. One such process includes loading a number of wafers into a quartz carrier or “boat” and then dipping them into an acid bath. As another example, wafers are held in a boat and placed in a chamber for deposition, oxidation, diffusion, or annealing.

The boat and many other processing components are commonly made from quartz, primarily because quartz is better than most materials at withstanding the hot or acidic environments during the various processing steps. Semiconductor wafers can be damaged easily by the introduction of even a few stray impurities. Accordingly, the choice of materials for semiconductor processing equipment must consider whether the material will shed particles during processing, thereby contaminating the wafers.

While quartz has been found to be superior to its presently available alternatives, even quartz is far from perfect for such applications. Pure quartz will shed particles over time, introducing impurities into the acid bath and potentially contaminating the wafers. Even if the wafers are not contaminated, the quartz components will erode, requiring frequent replacement of the boats, bath, and other components. Despite the fact that such quartz components are enormously expensive, the routine replacement of quartz processing equipment is standard in the industry.

Some manufacturers have attempted to construct wafer boats from other materials, such as pure Teflon. Pure Teflon, however, is too porous and absorbs acid. In addition, it is too heat sensitive and will not maintain its integrity and rigidity when dipped in an acid bath. Metals, plastics, and other materials all have disadvantages that prevent them from being suitable choices for wafer processing.

Accordingly, there is a need for improved semiconductor processing equipment that can tolerate hot and acidic environments while maintaining rigidity and without substantial shedding of particulates.

### SUMMARY OF THE INVENTION

The present invention comprises a wafer boat, bath, or related components that are covered with a fluoropolymer coating. In a preferred form, the components have standard quartz structures that are covered with a protective fluoropolymer coating. In alternate embodiments, glass, plastic, or even metal is used for the structure of the boat, tank, arms, or related components, then covered with a protective layer of fluoropolymer. In accordance with another preferred aspect, the coating is clear. In alternate embodiments, however, the coating includes a pigment. In some preferred embodiments, the coating comprises multiple layers with different colors for each layer so that wear will be readily apparent.

### BRIEF DESCRIPTION OF THE DRAWINGS

The preferred and alternative embodiments of the present invention are described in detail below with reference to the following drawings.

FIG. 1 is a perspective view of a wafer boat and acid bath in accordance with a preferred embodiment;

FIG. 2 is a top plan view of an acid bath having a submerged heating element in accordance with the present invention;

FIG. 3 is a perspective view of a carrying apparatus for a wafer boat; and

FIG. 4 is a representative view of a laminate coating applied to a substrate.

### DETAILED DESCRIPTION OF THE INVENTION

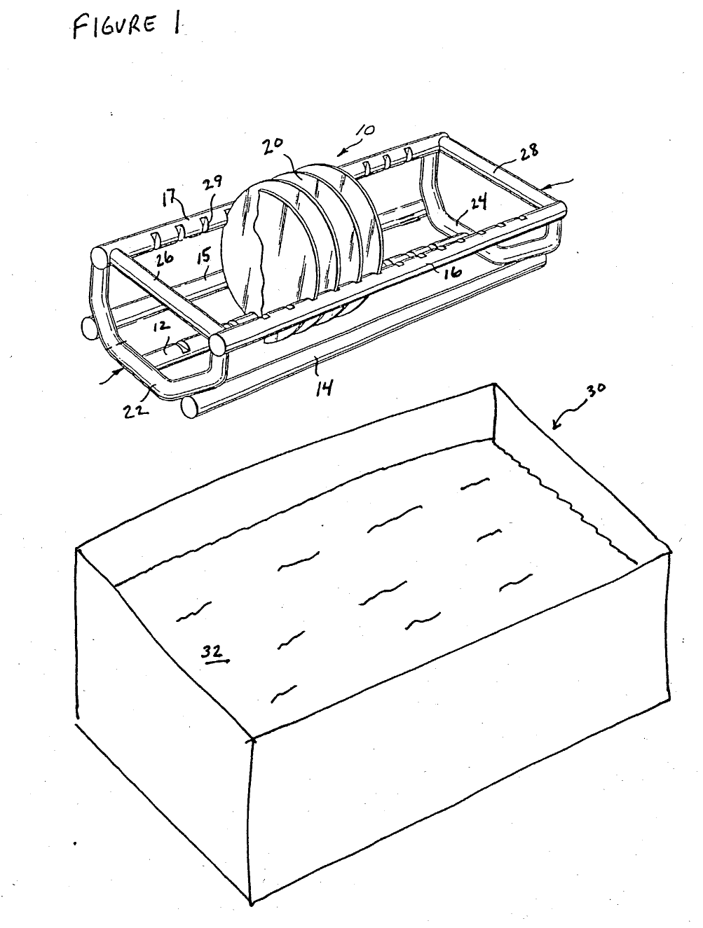

FIG. 1 depicts a wafer boat 10 carrying a plurality of wafers 20 above an acid tank 30. The composition of the wafers 20 can vary, but is preferably silicon or any other semiconductor material. The boat 10 includes a center bottom rail 12, first and second bottom side rails 14, 15, and first and second top side rails 16, 17. The bottom and side rails are attached to a generally U-shaped front end bracket 22 and an opposing back end bracket 24. A front top rod 26 connects the top side rails 16, 17 at a first end, while a back top rod 28 connects the top side rails 16, 17 at the opposite end. The top side rails 16, 17 and center bottom rail 12 each have a plurality of slots 29 sized and shaped to receive and hold a wafer 20. A wafer boat of this type is disclosed in U.S. Pat. No. 4,355,974, the text of which is incorporated by reference.

The form of the boat 10 as depicted in FIG. 1 is exemplary, and can take many alternative forms. For example, it could be configured to retain multiple rows of wafers, side by side. As another example, the boat 10 may be shaped differently, or may have longer or shorter rails. Primarily, the boat 10 need only be configured to hold one or more wafers for processing. It should be further understood that, consistent with this invention, the boat may be configured to hold items other than wafers that are intended to be subjected to similar processing.

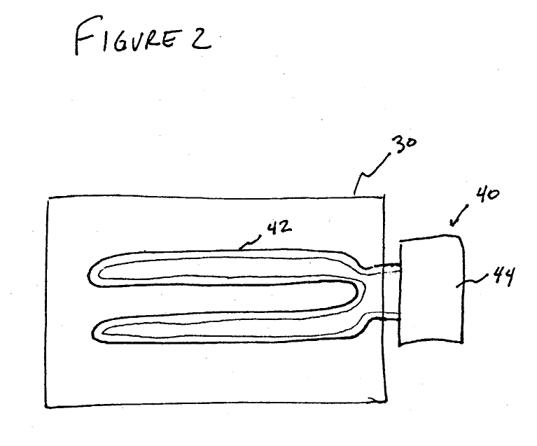

The particular process depicted in FIG. 1 is a process of dipping the wafers into an acid bath. The acid bath includes a tank 30 filled with an acid 32. Although an acid bath is a common processing step, other substances such as water, cleansers, solvents, coatings, or other liquids may be used instead of acid. In a typical configuration, the tank 32 includes a heater 40 as shown in FIG. 2. The heater includes a heating element 42 submerged in the bath, and an external source 44 for providing an electrical current or other means of heat to the heating element 42. Alternatively, the heating element 42 can be located outside the tank 30, rather than submerged.

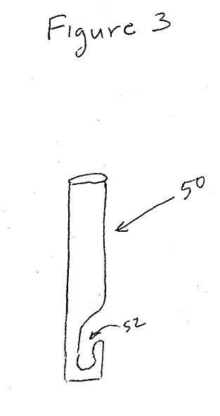

FIG. 3 depicts an arm 50 for carrying the boat. The arm 50 preferably is formed from a generally cylindrical section of quartz, and includes a notch 52 at a bottom end. The notch serves as a sort of “hook” to grasp and retain any one of the top rods of the boat. Thus, in one form one arm 50 holds one end of a boat by retaining the front top rod 26 within the notch 52, while another arm holds the opposite end of the boat by retaining the back top rod 28 within that arm's notch. In this manner, the arms can carry the boat to the tank. The arms can be manually or robotically dipped into the tank until the boat is submerged. The arms will also be at least partially submerged.

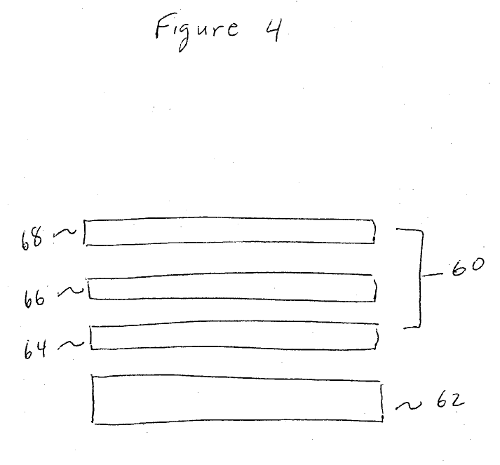

The principal processing components, including the boat 10, tank 30, arms 50, and heating element 42, are covered by a fluoropolymer coating 60, as shown representatively in FIG. 4. The coating 60 can include a base primer layer 64 used to facilitate an adequate bond between the substrate 62 and subsequent coating layers. The coating may also include one or more intermediate coating layers 66 and a top coating layer 68. Although the preferred embodiment includes only a single top layer 68, the coating 24 may comprise additional or fewer layers, as desired.

As used here, the term “substrate” means the surface of any part, equipment component, or other object that can be coated. In the preferred form, the substrate is the surface of quartz boat components, the quartz tank, the quartz arms, or other wafer processing components.

The coating used in the present invention is a fluoropolymer such as PFA, FEP, ETFE, ECTFE, or other type of fluoropolymer. In an actual embodiment, the coating is an ECTFE fluoropolymer commercially available under the trademark Halar®and sold by Ausimont USA, Inc., 10 Leonards Lane Thorofare, N.J. 08086, USA. Fluoropolymers are also available from Dupont, under the brand names Tefzel®and Teflon®, or other sources.

Although the preferred coating is clear, colored coatings may also be used. In a colored form, generally one coat, preferably the intermediate coat 28, of the laminate coating 24 is blended with a colorant or other additive to give it a distinctive color. A wide array of pigments for fluoropolymers is generally available. Preferably, the fluoropolymer is blended with the pigment at a ratio of about 50 grams of pigment to 5 pounds of fluoropolymer.

In an alternate embodiment, multiple layers of the coating contain different colored pigments. Thus, for example, a layer close to the substrate (such as the primer layer or an intermediate layer) can be colored gray, while an adjacent layer is colored blue. When the blue layer begins to wear, the gray layer will become visible, signaling that it is time to replace or recoat the part. Any number of colors and layers may be used to accomplish the wear-indicating result, although the two colors preferably are chosen contrast with one another so that when the top layer begins to wear the lower layer is readily visible.

Quartz parts generally need not be “roughed up” in accordance with the preferred method of coating application, although it may sometimes be useful. If the part is to be roughed up, the part can be blasted with 80-grit aluminum oxide to rough up the surface to improve adhesion of the coating. While a grit-blast with 80-grit aluminum oxide is preferred, the surface may be roughed up in other manners, or using a different materials other than 80 grit aluminum oxide.

Once the surface is prepared by roughing up surfaces to be coated, the article (such as a boat 10) is then pre-baked at 560° F. for about 15 minutes to remove impurities, improve the bonding ability, and prevent out-gassing under the coating.

In the preferred form, no primer or intermediate coats are used. If a primer coat is employed, the article is coated with a chemical resistant fluoropolymer primer and baked, followed by an application of any number of intermediate coats of fluoropolymer that are applied at a preferred thickness of about 3 mils and baked at 500° F. for 15 minutes. Additional coats of the fluoropolymer are added and baked in the same manner until a preferred thickness is achieved. The final thickness is preferably achieved by applying several coats of fluoropolymer material. This thickness may alternatively be produced by a greater or lesser number of coatings, depending on the thickness of the individual coats applied.

A top coating 30 of fluoropolymer is also applied. In the preferred form, only a single coating is used, and that single coating is in the form of the top coating described here. In other words, the top coating is applied directly to the substrate. The top coating 30 is preferably a clear fluoropolymer, having no added pigment. The top coating is preferably a thin coat of about 3 mils. Once applied, the article is baked at 490° F. for about 10-15 minutes.

While the temperatures and baking times described above have been found to be suitable for applying a fluoropolymer such as ECTFE, both the temperature and baking times may be varied, consistent with this invention.

The part is allowed to cool to room temperature, and then inspected to determine whether the desired thickness, smoothness, and any other desired attributes have been achieved. If the coating is not thick enough or is otherwise unacceptable, further coating layers can be added. Likewise, it is possible to either reheat and reflow the coating, or to strip the coating and start again. Upon meeting the established criteria for uniform and complete coverage, showing no delaminations or release of coating, no pinholes, and uniform color, thickness and surface texture, the part is accepted.

The resulting application produces a nonstick surface that is heat, chemical, and abrasion resistant. If one or more of the coating layers includes a pigment, the pigment allows users to see when the coating is starting to wear at the earliest stages, providing a forewarning that parts may have to be removed, cleaned, re-coated, or replaced.

FIG. 1 illustrates a coated boat carrying several wafers for processing, including dipping into an acid bath. Likewise, the surfaces of the acid bath tank 30 and heating element 42 have been coated as described above with a fluoropolymer coating. Thus, the boat 10, heating element 42, and tank 30 are better able to withstand the corrosive environment produced by the acid 32. Accordingly, the coated components shed fewer contaminants and require replacement less frequently than untreated quartz components.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

I claim:

1. A component for processing wafers, comprising:
a substrate constructed from quartz; and
a fluoropolymer coating on the substrate.

2. The component of claim 1, wherein the component is a wafer carrier.

3. The wafer carrier of claim 2, further comprising a bottom rail, a first side rail, and a second side rail, wherein each of the bottom rail, first side rail, and second side rail are constructed from quartz and include a fluoropolymer coating.

4. The wafer carrier of claim 3, further comprising a first end bracket attached to a first end of each of the bottom rail, first side rail, and second side rail, and a second end bracket attached to a second end of each of the bottom rail, first side rail, and second side rail, and further wherein the first end bracket and second end bracket are each constructed from quartz and coated with a fluoropolymer coating.

5. The wafer carrier of claim 4, wherein the bottom rail, first side rail, and second side rail further comprise a plurality of slots and each slot is configured to receive a wafer.

6. The wafer carrier of claim 2, further comprising a first side support and a second side support arranged to define a wafer-receiving space between them, and further wherein the first side support and second side support are each constructed from quartz and include a fluoropolymer coating.

7. The component of claim 1, wherein the component is a tank.

8. The tank of claim 7, wherein the tank comprises a bottom and four side walls, and further wherein each of the bottom and four side walls is at least partially coated with a fluoropolymer coating.

9. The tank of claim 7, wherein the tank comprises a bottom and four side walls, and further wherein each of the bottom and four side walls is fully coated with a fluoropolymer coating.

10. The tank of claim 8, further comprising a heater adapted to heat a liquid within the tank, wherein the heater comprises a heating element coated with a fluoropolymer coating.
